(19) United States
(12) Patent Application Publication
(10) Pub. No.: US 2014/0178082 A1
(43) Pub. Date: Jun. 26, 2014

(54) HIGH VOLTAGE POWER SUPPLY WITHOUT OUTPUT VOLTAGE ADJUSTMENT, METHOD OF ADJUSTING OUTPUT VOLTAGE OF THE HIGH VOLTAGE POWER SUPPLY IN IMAGE FORMING APPARATUS, AND IMAGE FORMING APPARATUS USING THE METHOD

(71) Applicant: Samsung Electronics Co., Ltd., Suwon (KR)

(72) Inventor: Yun-tae KIM, Suwon (KR)

(73) Assignee: SAMSUNG ELECTRONICS CO., LTD., Suwon (KR)

(21) Appl. No.: 14/036,726

(22) Filed: Sep. 25, 2013

(30) Foreign Application Priority Data
Dec. 24, 2012 (KR) 10-2012-0152495

(51) Int. Cl. G03G 15/00

(52) U.S. Cl. CPC G03G 15/5004
USPC 399/12; 399/88

(57) ABSTRACT

A high voltage power supply (HVPS) without an output voltage adjustment, a method of adjusting an output voltage of a HVPS, and an image forming apparatus using the method are provided. The image forming apparatus includes a high-voltage output unit that outputs a high voltage produced by the HVPS, a tag that stores an offset voltage information and is attached to the HVPS, and a high-voltage output control unit that reads the tag attached to the HVPS to extract the offset voltage information, and corrects a high-voltage output control signal by using the offset voltage information to change the high voltage output by the high-voltage output unit. Accordingly, a process of adjusting an output voltage of an HVPS as a single component is not required. The manufacturing costs of HVPSs are reduced, and the process of finely adjusting an output voltage of the HVPS is simplified.

### CROSS-REFERENCE TO RELATED APPLICATIONS

This application is related to, and claims priority to, Korean Patent Application No. 10-2012-0152495, filed on Dec. 24, 2012, in the Korean Intellectual Property Office, the disclosure of which is incorporated herein in its entirety by reference.

### BACKGROUND

1. Field

Exemplary embodiment of the present invention relate to a high voltage power supply (HVPS) and an image forming apparatus including the HVPS, and more particularly, to an HVPS capable of finely adjusting a output voltage of the HVPS without using a variable resistor that can finely adjust an output voltage of an HVPS, a method of adjusting the output voltage of the HVPS, and an image forming apparatus using the method.

2. Description of the Related Art

A high voltage power supply (HVPS) installed in an electrophotographic image forming apparatus controls toner particles and supplies a high voltage used to form an image. The supplied high voltage needs to satisfy a demand for high precision. In particular, voltages that are supplied to a toner supply and a charging roller are required to be output voltages within a deviation range of about 3%. To output a voltage within such a deviation range, the precision of an output voltage may be satisfied by controlling a deviation of the output voltage by using a variable resistor.

When an HVPS is manufactured, a variable resistor may be installed in the HVPS in order to adjust the precision of an output voltage of the HVPS. An HVPS supply company may adjust a fabricated HVPS while testing the fabricated HVPS, in order to adjust an output voltage of the HVPS to a target voltage. To prevent a resistance adjusting portion of a variable resistor from being twisted during circulation of HVPSs, an additional operation, such as fixing of the resistance adjusting portion of the variable resistor due to bonding, may be required.

Such an additional operation of finely adjusting the output voltage of an HVPS leads to increases in the manufacturing steps and cost of HVPSs, and many HVPS management items are created.

### SUMMARY

Additional aspects and/or advantages will be set forth in part in the description which follows and, in part, will be apparent from the description, or may be learned by practice of the invention.

According to an aspect of the present invention, an image forming apparatus is provided that replaces with a fixed resistor a variable resistor necessary for finely adjusting an output voltage of an high voltage power supply (HVPS) to a reference target voltage and that does not perform output voltage adjustment using the variable resistor when the HVPS exists as a single component, and adjusts the output voltage of the HVPS by using deviation information stored in a tag attached to the HVPS when the HVPS is assembled into the image forming apparatus.

According to an aspect of the present invention, a method of adjusting an output voltage of an HVPS is provided, in which a variable resistor necessary for finely adjusting the output voltage of an HVPS to a reference target voltage is replaced by with a fixed resistor, and output voltage adjustment using the variable resistor is not performed when the HVPS exists as a single component, and the output voltage of the HVPS is adjusted using deviation information stored in a tag attached to the HVPS when the HVPS is assembled into an image forming apparatus.

According to an aspect of the present invention, an HVPS is provided without output voltage adjustment that replaces with a fixed resistor a variable resistor necessary for finely adjusting the output voltage of the HVPS to a reference target voltage, wherein, when the HVPS exists as a single component, output voltage adjustment using the variable resistor is not performed, and, when the HVPS is assembled into an image forming apparatus, the output voltage of the HVPS is adjusted using deviation information stored in a tag attached to the HVPS.

According to an aspect of the present invention, t an image forming apparatus is provided including a high-voltage output unit that is included in an HVPS and outputs a high voltage produced by the HVPS, a tag that stores information about an offset voltage and is attached to the HVPS, when a difference between the high voltage output by the high-voltage output unit and a preset reference output voltage of the HVPS is referred to as the offset voltage, and a high-voltage output control unit that reads the tag attached to the HVPS to extract the information about the offset voltage, and corrects a high-voltage output control signal by using the information about the offset voltage to change the high voltage output by the high-voltage output unit.

The high-voltage output control unit may include a memory that stores the information about the offset voltage and a correction value that corresponds to the information about the offset voltage and corrects the high-voltage output control signal, in the form of a look-up table, wherein the high-voltage output control signal is a pulse-width modulation (PWM) signal; and a high-voltage output control signal correction unit that reads the correction value from the look-up table stored in the memory by using the information about the offset voltage, and corrects the high-voltage output control signal by using the read-out correction value. The information about the offset voltage may be offset grade information about grades into which offset voltages are classified in units of predetermined offset voltage ranges, and correction values may be matched for offset voltage grades in the look-up table. The high-voltage output control signal may be a PWM signal, and the correction value is duty information of the PWM signal. The tag attached to the HVPS may be a barcode or a radio-frequency identification (RFID) tag. When the tag is a barcode, the barcode may be read using a barcode reader. When the tag is an RFID tag, the RFID tag may be read using an RFID reader.

According to an aspect of the present general inventive concept, an image forming apparatus is provided including a high-voltage output unit that is included in an HVPS and outputs a high voltage produced by the HVPS, a serial number that is attached to the HVPS and to which information about an offset voltage is added, when a difference between the high voltage output by the high-voltage output unit and a preset reference output voltage of the HVPS is referred to as the offset voltage, a database that stores information associated with a serial number of the HVPS, and a high-voltage output control unit that reads the serial number attached to the HVPS to extract the information about the offset voltage, and corrects a high-voltage output control signal with reference to a result of searching the database to change the high voltage output by the high-voltage output unit.

The high-voltage output control signal may be a PWM signal, and the correction value may be duty information of the PWM signal.

According to an aspect of the present invention, a method of adjusting an output voltage of an HVPS is provided, the method comprising manufacturing the HVPS and measuring an output voltage of the HVPS, recording information about an offset voltage in a tag attached to the HVPS, when a difference between the measured output voltage of the HVPS and a preset reference output voltage of the HVPS is referred to as the offset voltage, extracting the information about the offset voltage by reading the tag attached to the HVPS when the HVPS is installed in an image forming apparatus, and changing the output voltage of the HVPS by correcting the high-voltage output control signal by using the information about the offset voltage, wherein the changing of the output voltage is performed by the image forming apparatus.

A changing of the output voltage of the HVPS may include acquiring a correction value by reading a look-up table pre-stored in a memory by using the information about the offset voltage, wherein the acquiring is performed by the image forming apparatus, and changing the output voltage of the HVPS by correcting the high-voltage output control signal by using the correction value. The high-voltage output control signal may be a PWM signal, and the correction value may be duty information of the PWM signal.

According to an aspect of the present general inventive concept, there is provided an HVPS including a high-voltage producing unit that produces a high voltage, a high-voltage output unit that outputs the high voltage, and a tag that stores information about an offset voltage and is attached to the HVPS, when a difference between the high voltage output by the high-voltage output unit and a preset reference output voltage of the HVPS is referred to as the offset voltage.

The tag may include a serial number of the HVPS.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates an exemplary embodiment of a general technique associated with the present invention;

FIG. 2 illustrates an exemplary image forming apparatus according to an embodiment of the present invention;

FIG. 3 illustrates an exemplary image forming apparatus according to an embodiment of the present invention;

FIG. 4 is a flowchart illustrating an exemplary method of adjusting an output voltage of a high voltage power supply (HVPS) of an image forming apparatus, according to an embodiment of the present invention; and

FIG. 5 is a flowchart illustrating an exemplary method from a manufacture of an HVPS to assembly of an image forming apparatus using an exemplary method of adjusting an output voltage of an HVPS according to the present invention.

### DETAILED DESCRIPTION

Exemplary embodiments of the present invention are described with reference to the accompanying drawings, in which exemplary embodiments of the present invention are illustrated. However, the description proposed herein is just an example for the purpose of illustrations only, not intended to limit the scope of the present invention, so it should be understood that other equivalents and modifications could be made thereto at the time of filing of the present application without departing from the spirit and scope of the present invention.

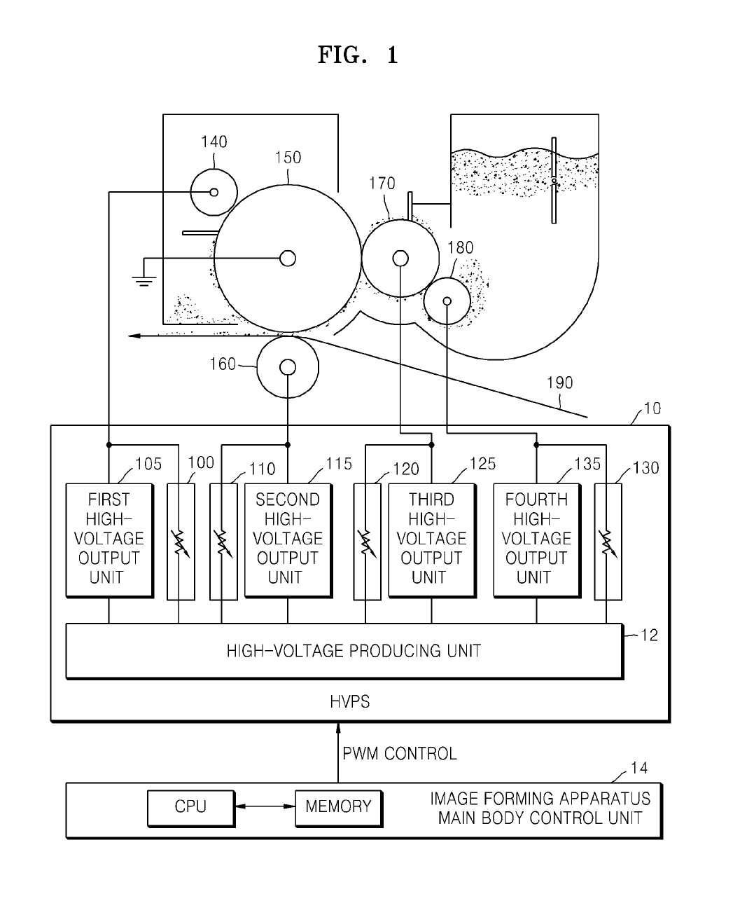

FIG. 1 is a structural diagram conceptually illustrating a general technique associated with the present invention. According to the present invention, fixed resistors may be used instead of variable resistors 100, 110, 120, and 130 for fine adjustment included in a general circuit.

Referring to FIG. 1, a photosensitive drum 160 may be grounded, and a high voltage produced by a high-voltage producing unit 12 of a general high-voltage power supply (HVPS) 10 supplied to a charging roller 140, a developing roller 170, a toner supply roller 180, and a transfer roller 160 via a first high-voltage output unit 105, a third high-voltage output unit 125, a fourth high-voltage output unit 135, and a second high-voltage output unit 115, respectively. While a recording sheet 190 is passing between the photosensitive drum 150 and the transfer roller 160, a toner may be attached to an image developed to fix on the recording sheet 190.

In a circuit of HVPS 10, as illustrated in FIG. 1, the variable resistors 100, 110, 120, and 130 for fine adjustment may be applied to an output port terminal or a control port terminal. An HVPS supply company may assemble the general HVPS 10, adjust the variable resistors 100, 110, 120, and 130 of the assembled general HVPS 10 during a test process so that a voltage that is output via an output port of the general HVPS 10 is a preset output voltage, and supply the HVPS 10 of which output voltage was adjusted. HVPSs may have somewhat different specifications for different models, but the output voltage precision of each HVPS may be maintained as a level of 3% to 5%. Thus, the variable resistors 100, 110, 120, and 130 may be installed in the HVPS 10 to check whether an output voltage of the general HVPS 10 is within a preset standard. The HVPS 10 including the variable resistors 100, 110, 120, and 130 may be installed in an image forming apparatus.

Accordingly, a process of checking whether a preset target voltage is output by adjusting the variable resistors 100, 110, 120, and 130 is included, and a process of bonding the variable resistors 100, 110, 120, and 130 to prevent their voltage adjusting portions from being twisted is included.

An HVPS that has passed the target voltage output checking process and the bonding process may be installed in a system to be equipped with an HVPS, such as, in an image forming apparatus. A voltage output by an HVPS may have different values according to an environment in which the HVPS is used. The HVPS output voltage may be adjusted and controlled via a pulse-width modulation (PWM) method within the system according to an environment in which the HVPS is used. For example, a voltage of −300V to −500V may be supplied to a developing roller, and a voltage of −1.3 KV to −1.5 KV may be supplied to a charging roller. A precision of the HVPS output voltage should maintain a level of 3% to 5% for each component to which the HVPS output voltage is supplied.

In an exemplary embodiment of the present invention, since the HVPS output voltage is adjusted due to PWM capable of voltage control, a variable resistor may be replaced by a fixed resistor. Information about a deviation of an HVPS output voltage may be stored in a barcode or connected to an HVPS manufacturing system so that an offset voltage corresponding to the deviation of the HVPS output voltage is reflected in a system equipped with an HVPS. Thus, the same output voltage as an HVPS output voltage finely adjusted by a variable resistor may be represented as an output voltage of an HVPS installed in a system. A deviation of an HVPS output voltage from a reference voltage may be pre-set in units of grades or levels, and actually-checked HVPS voltage deviations (i.e., offset voltages) are matched with the set grades or levels.

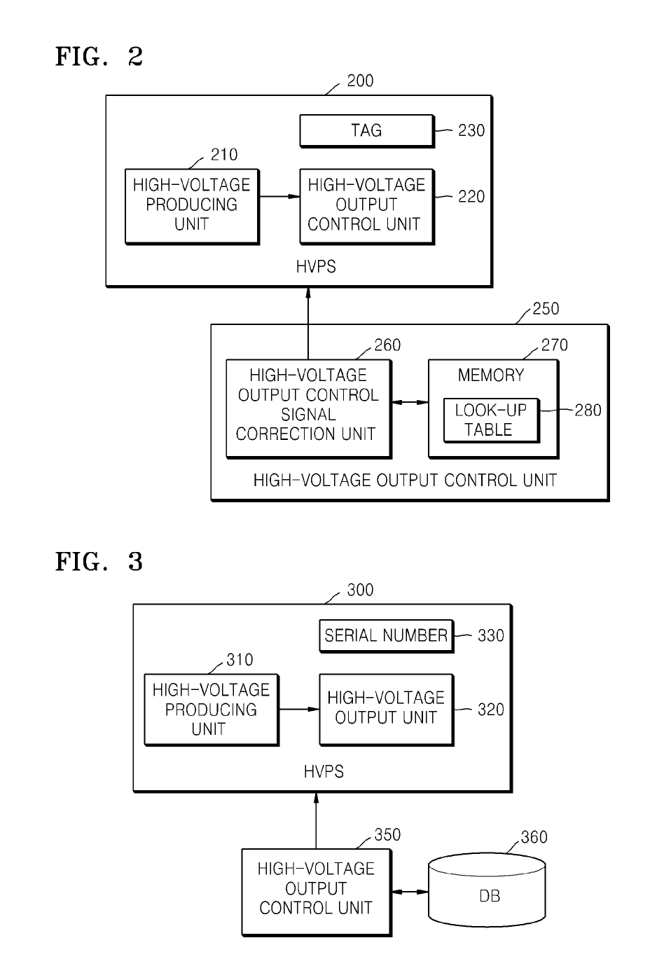

FIG. 2 illustrates an exemplary image forming apparatus according to an embodiment of the present invention. The image forming apparatus of FIG. 2 includes an HVPS 200 and a high-voltage output control unit 250.

Referring to FIG. 2, the HVPS 200 includes a high-voltage producing unit 210, a high-voltage output unit 220, and a tag 230.

The high-voltage producing unit 210 produces a high voltage that may be necessary for an image forming unit (not shown) of the image forming apparatus. In an exemplary electrophotographic image forming apparatus, a voltage supplied to a transfer roller may be −800V to −2.2 KV DC(THV+) and −700V to −1.3 KV DC(THV−), a voltage supplied to a developing roller may be −300V to −500V DC, and a voltage supplied to a charging roller may be −1.3 KV to −1.5 KV DC.

The high-voltage output unit 220 is included in the HVPS 200, and a high voltage produced by the high-voltage producing unit 210 may be output to the image forming unit of the image forming apparatus.

A difference between the high voltage output by the high-voltage output unit 220 and a preset reference output voltage of the HVPS 200 may be defined as an offset voltage. The tag 230 may store information about the offset voltage and may be attached to the HVPS 200.

The high-voltage output control unit 250 reads the tag 230 attached to the HVPS 200 to extract the information about the offset voltage, and corrects a high-voltage output control signal by using the information about the offset voltage to finely adjust the output voltage of the high-voltage output unit 220. The operations of the high-voltage output control unit 250 reading the tag 230 attached to the HVPS 200 to extract the information about the offset voltage and adjusting the high-voltage output control signal by using the information about the offset voltage to finely adjust the output voltage of the high-voltage output unit 220 may be performed when the HVPS 200 is installed in the image forming apparatus.

The tag 230 attached to the HVPS 200 may be a barcode or a radio-frequency identification (RFD) tag. When the tag 230 is a barcode, the information about the offset voltage stored in the barcode is read using a barcode reader, and, when the tag 230 is an RFID tag, the information about the offset voltage stored in the RFID tag is read using an RFID reader.

The high-voltage output control unit 250 includes a high-voltage output control signal correction unit 260 and a memory 270.

The memory 270 stores the information about the offset voltage and a correction value that corresponds to the information about the offset voltage and corrects the high-voltage output control signal, in the form of a look-up table 280.

The high-voltage output control signal correction unit 260 reads the correction value from the look-up table 280 stored in the memory 270 by using the information about the offset voltage, and corrects the high-voltage output control signal by using the read-out correction value. The high-voltage output control signal may be a PWM signal, and the correction value may be duty information of the PWM signal.

The information about the offset voltage may be offset grade information about grades into which offset voltages are classified in units of predetermined deviation ranges, and correction values may be matched for offset voltage grades in the look-up table 280. For example, when a difference between a measured output voltage of the HVPS 200 and a preset reference voltage is defined as an offset voltage, if the offset voltage is within 2% of the reference voltage, the offset voltage may be classified as “grade 1.” If the offset voltage is within 3%, the offset voltage may be classified as “grade 2.” If the offset voltage is within 5%, the offset voltage may be classified as “grade 3.” The grade information may be set as the offset voltage information and stored in the tag 230.

When the offset voltage is within 2% and thus the offset voltage information is “grade 1,” the look-up table 280 matches a PWM correction value with a value of “0”. When the offset voltage is within 3% and thus the offset voltage information is “grade 2,” the look-up table 280 matches a PWM correction value with a value of “10”. When the offset voltage is within 5% and thus the offset voltage information is “grade 3,” the look-up table 280 matches a PWM correction value with a value of “15.”

When an HVPS outputs a high voltage via PWM control, the high voltage output by the HVPS is finely adjusted using the PWM correction value.

FIG. 3 illustrates an exemplary image forming apparatus according to an embodiment of the present invention. The image forming apparatus of FIG. 3 includes an HVPS 300, a high-voltage output control unit 350, and a database (DB) 360.

Referring to FIG. 3, the HVPS 300 includes a high-voltage producing unit 310, a high-voltage output unit 320, and a serial number 330.

The high-voltage producing unit 310 produces a high voltage necessary for an image forming unit (not shown) of the image forming apparatus. In an electrophotographic image forming apparatus, a voltage supplied to a transfer roller may be −800V to −2.2 KV DC(THV+) and −700V to −1.3 KV DC(THV−), a voltage supplied to a developing roller may be −300V to −500V DC, and a voltage supplied to a charging roller may be −1.3 KV to −1.5 KV DC.

The high-voltage output unit 320 is included in the HVPS 300, and a high voltage produced by the high-voltage producing unit 310 is output to the image forming unit of the image forming apparatus.

The serial number 330 is attached to the HVPS 300. A difference between the high voltage output by the high-voltage output unit 320 and a preset reference output voltage of the HVPS 300 may be referred to as an offset voltage. Offset voltage information as may be added to the serial number 330. The serial number 330 may be configured as a barcode or an RFID form.

The DB 360 stores information associated with the serial number 330 of the HVPS 300. The information associated with the serial number 330 stored in the DB 360 may include a correction value used to control a PWM signal, in order for the high-voltage output control unit 350 to output a preset reference voltage as the output voltage of the high-voltage output unit 320.

The high-voltage output control unit 350 reads the serial number 330 attached to the HVPS 300 via a barcode reader or an RFID reader to extract the offset voltage information, and adjusts a high-voltage output control signal with reference to a result of searching the DB 360 by using the offset voltage information to finely adjust the output voltage of the high-voltage output unit 320. The fine adjustment of the output voltage of the high-voltage output unit 320 may be performed when the HVPS 300 is installed in the image forming apparatus. The high-voltage output control signal may be a PWM signal, and the correction value may be duty information of the PWM signal.

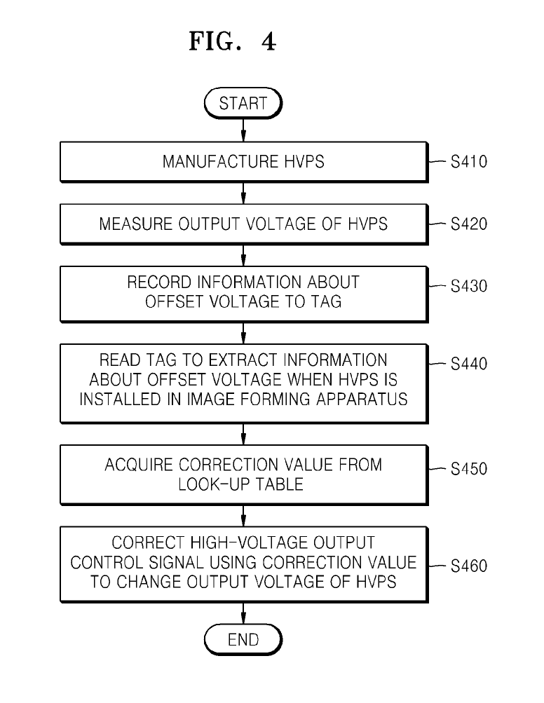

FIG. 4 illustrates an exemplary method of adjusting an output voltage of the HVPS 200 of FIG. 2, according to an embodiment of the present invention. An exemplary method of adjusting the output voltage of the HVPS 200 is described with reference to FIGS. 2 and 4.

In operation S410, an HVPS manufacturer manufactures the HVPS 200. When the HVPS 200 is manufactured, an output voltage of the HVPS 200 is measured, in operation S420.

In operation S430, when a difference between the measured output voltage of the HVPS 200 and a preset reference voltage of the HVPS 200 is referred to as an offset voltage, information about the offset voltage is stored in the tag 230 attached to the HVPS 200.

In operation S440, the tag 230 attached to the HVPS 200 is read to extract the information about the offset voltage. The tag 230 may be a barcode or an RFID tag. The tag 230 may be read using a barcode reader or an RFID reader. The reading of the tag 230 attached to the HVPS 200 to extract the information about the offset voltage may be performed when the HVPS 200 is installed in the image forming apparatus.

The high-voltage output control unit 250 of the image forming apparatus corrects the high-voltage output control signal by using the offset voltage information and adjusts the output voltage of the HVPS 200 to the preset reference voltage by using the corrected high-voltage output control signal. The high-voltage output control unit 250 of the image forming apparatus acquires a correction value from the look-up table 280 pre-stored in the memory 270 by using the offset voltage information, in operation S450. In operation S460, the high-voltage output control signal is corrected using the correction value to change the output voltage of the HVPS 200. The high-voltage output control signal may be a PWM signal, and the correction value may be duty information of the PWM signal.

The offset voltage information may be offset grade information about grades into which offset voltages are classified in units of predetermined offset voltage ranges, and correction values may be matched for offset voltage grades in the look-up table 280. For example, when a difference between a measured output voltage of the HVPS 200 and a preset reference voltage is referred to as an offset voltage, if the offset voltage is within 2% of the reference voltage, the offset voltage is classified as “grade 1.” If the offset voltage is within 3%, the offset voltage is classified as “grade 2.” If the offset voltage is within 5%, the offset voltage is classified as “grade 3.” The grade information may be stored as the offset voltage information in the tag 230.

When the offset voltage is within 2% and thus the offset voltage information is “grade 1,” the look-up table 280 matches a PWM correction value with a value of “0”. When the offset voltage is within 3% and thus the offset voltage information is “grade 2,” the look-up table 280 matches a PWM correction value with a value of “10.” When the offset voltage is within 5% and thus the offset voltage information is “grade 3,” the look-up table 280 matches a PWM correction value with a value of “15”.

When an HVPS outputs a high voltage via PWM control, the high voltage is finely adjusted using such a correction value.

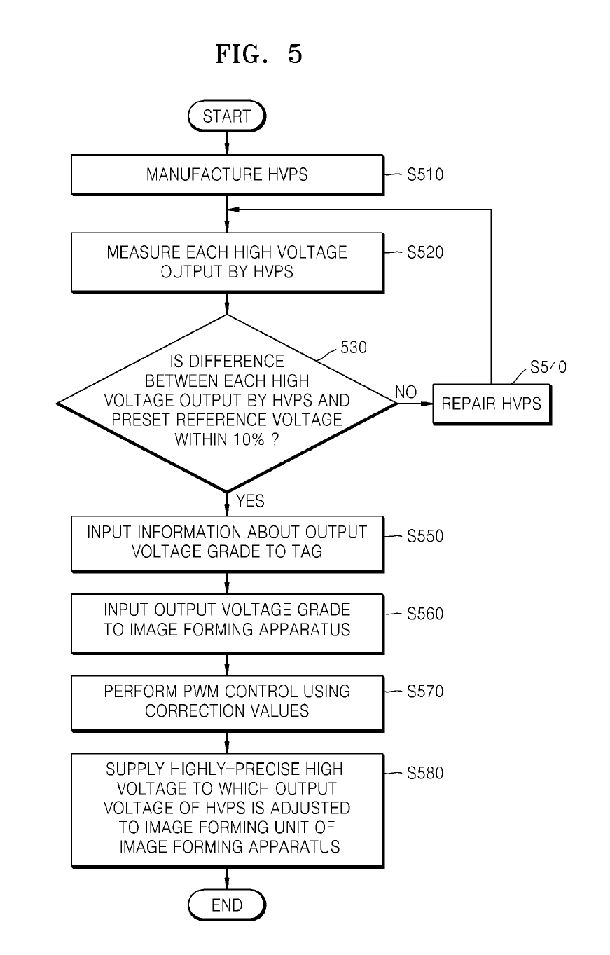

FIG. 5 is a flowchart of processes ranging from the manufacture of an HVPS to the assembly of an image forming apparatus by using a method of adjusting an output voltage of an HVPS according to an exemplary embodiment of the present invention.

Referring to FIG. 5, after an HVPS manufacturer completes the assembly of an HVPS in operation S510, each of a plurality of high voltages output by the HVPS may be measured, in operation S520. If a difference between each of the high voltages output by the HVPS and a preset reference voltage exceeds 10% in operation S530, the HVPS may be repaired, in operation S540.

In operation S550, a difference between a re-measured output voltage of a repaired HVPS and the predetermined reference voltage is graded. A difference grade may be defined as an output voltage grade. Information about the output voltage grade may be stored in the form of a barcode or an RFID tag. The barcode or RFID tag may be attached to the HVPS or marked on the HVPS. In other words, when an HVPS is manufactured as a component, an output voltage of the HVPS is measured, and a deviation of the measured output voltage from a predetermined reference voltage may be graded in consideration of the level of a voltage supplied to each component of an image forming apparatus. For example, when the difference is within 2%, it is classified as “grade 1.” When the difference is within 3%, it is classified as “grade 2.” When the difference is within 5%, it is classified as “grade 3.” The grade information may be stored in a tag via a barcode, an RFID tag, or marking, and the tag is attached to the HVPS. In other words, while deviations of high voltages output by an HVPS are about 10% in the prior art, whereas, in an exemplary embodiment of the present invention, the deviations are lowered and adjusted to the level of 3% to 5%.

In operation S560, when the HVPS that stores such a difference grade in a tag is assembled into an image forming apparatus, a barcode or an RFIG tag attached to the HVPS may be read via a barcode reader or an RFID reader to extract the output voltage grade, and the output voltage grade is input to the image forming apparatus. The output voltage grade may be input to the image forming apparatus by executing a special program installed in the image forming apparatus.

In operation S570, the image forming apparatus stores the output voltage grade of the HVPS within a memory, and PWM control may be performed using correction values matched according to output voltage grades when the image forming apparatus is driven. In operation S580, a highly-precise high voltage to which the output voltage of the HVPS is adjusted is supplied to an image forming unit of the image forming apparatus so that printing starts.

An image forming apparatus may perform a voltage change via PWM control and perform a voltage adjustment via a variable resistor in order to adjust the output voltage of an HVPS. However, in an exemplary embodiment of the present invention, the voltage change and voltage adjustment may be integrated into one operation to adjust the output voltage of an HVPS.

In such a high-voltage adjusting method according to an exemplary embodiment of the present invention, when an HVPS exists independently as a single component, a voltage adjustment is not performed, and a deviation of the output voltage of the HVPS is just graded and stored in a tag. When the HVPS is assembled into an image forming apparatus, a voltage adjustment is performed by applying correction values to PWM control. Therefore, the high-voltage adjusting method according to an exemplary embodiment of the present invention may provide the same effect as a conventional voltage adjusting method using variable resistors.

The above-described embodiments of an exemplary embodiment of the present invention are not only applied to image forming apparatuses but may also be applied to various electronic apparatuses that use an HVPS. For example, the above-described embodiments of an exemplary embodiment of the present invention may be used when electronic apparatuses such as TVs, refrigerators, laundry machines use an HVPS.

In a non-adjustment HVPS, a method of adjusting an output voltage of the HVPS, and an image forming apparatus using the method according to an exemplary embodiment of the present invention, in contrast with a conventional method of adjusting the output voltage of an HVPS by adjusting variable resistors installed at an output port of the HVPS, only a deviation of the output voltage of the HVPS is simply ascertained and stored in a tag, and, when the HVPS is installed in the image forming apparatus, the grade of the deviation is extracted from the tag, and a correction value corresponding to the deviation grade is applied to PWM control, thereby adjusting the output voltage of the HVPS.

Accordingly, when an HVPS is manufactured, variable resistors for increasing the precision of the output voltage of the HVPS does not need to be installed in the HVPS.

When an HVPS supply company tests fabricated HVPSs, an operation of individually adjusting output voltages of the HVPSs to target voltages is not necessary. In addition, an additional operation, such as fixing of a variable resistor due to bonding to prevent a resistance adjusting portion of the variable resistor from being twisted during circulation of HVPSs is not necessary.

When an HVPS exists independently as a single component, a separate process of finely adjusting an output voltage of the HVPS is not necessary. Due to the non-use of variable resistors, the manufacturing costs of HVPSs are reduced, and the process of finely adjusting an output voltage of the HVPS is simplified, thereby lowering the costs of HVPSs.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image forming apparatus comprising:
a high-voltage output unit that is included in a high-voltage power supply (HVPS) and outputs a high voltage produced by the HVPS;
a tag that stores information about an offset voltage and is attached to the HVPS, wherein the offset voltage represents a difference between the high voltage output by the high-voltage output unit and a preset reference output voltage of the HVPS; and
a high-voltage output control unit that reads the tag attached to the HVPS to extract the information about the offset voltage, and corrects a high-voltage output control signal by using the information about the offset voltage to change the high voltage output by the high-voltage output unit.

2. The image forming apparatus of claim 1, wherein the high-voltage output control unit reads the tag attached to the HVPS to extract the information about the offset voltage, and corrects the high-voltage output control signal by using the information about the offset voltage to change the high voltage output by the high-voltage output unit, when the HVPS is installed in the image forming apparatus.

3. The image forming apparatus of claim 2, wherein the high-voltage output control unit comprises:
a memory that stores the information about the offset voltage and a correction value that corresponds to the information about the offset voltage and corrects the high-voltage output control signal, in the form of a look-up table, wherein the high-voltage output control signal is a pulse-width modulation (PWM) signal; and
a high-voltage output control signal correction unit that reads the correction value from the look-up table stored in the memory by using the information about the offset voltage, and corrects the high-voltage output control signal by using the read-out correction value.

4. The image forming apparatus of claim 2, wherein
the information about the offset voltage is offset grade information about grades into which offset voltages are classified in units of predetermined offset voltage ranges, and
correction values are matched for offset voltage grades in the look-up table.

5. The image forming apparatus of claim 3, wherein the high-voltage output control signal is a PWM signal, and the correction value is duty information of the PWM signal.

6. The image forming apparatus of claim 1, wherein the tag attached to the HVPS is a barcode or a radio-frequency identification (RFID) tag, and, when the tag is a barcode, the barcode is read using a barcode reader, and, when the tag is an RFID tag, the RFID tag is read using an RFID reader.

7. An image forming apparatus comprising:
a high-voltage output unit that is included in a high-voltage power supply (HVPS) and outputs a high voltage produced by the HVPS;
a serial number that is attached to the HVPS and to which information about an offset voltage is added, wherein the offset voltage represents a difference between the high voltage output by the high-voltage output unit and a preset reference output voltage of the HVPS;
a database that stores information associated with a serial number of the HVPS; and
a high-voltage output control unit that reads the serial number attached to the HVPS to extract the information about the offset voltage, and corrects a high-voltage output control signal with reference to a result of searching the database to change the high voltage output by the high-voltage output unit.

8. The image forming apparatus of claim 7, wherein the high-voltage output control signal is a PWM signal, and the correction value is duty information of the PWM signal.

9. A high-voltage power supply (HVPS) comprising:
a high-voltage producing unit that produces a high voltage;
a high-voltage output unit that outputs the high voltage; and
a tag that stores information about an offset voltage and is attached to the HVPS, wherein the offset voltage represents a difference between the high voltage output by the high-voltage output unit and a preset reference output voltage of the HVPS.

10. The HVPS of claim 9, wherein the tag comprises a serial number of the HVPS.

11. The image forming apparatus of claim 7, wherein the high-voltage output control unit reads the serial number attached to the HVPS to extract the information about the offset voltage, and corrects a high-voltage output control signal by referring to a result of searching the database to change the high voltage output by the high-voltage output unit.

12. A method of adjusting an output voltage of a high-voltage power supply (HVPS), the method comprising:
manufacturing the HVPS and measuring an output voltage of the HVPS;
recording information about an offset voltage in a tag attached to the HVPS, wherein the offset voltage represents a difference between the measured output voltage of the HVPS and a preset reference output voltage of the HVPS;
extracting the information about the offset voltage by reading the tag attached to the HVPS when the HVPS is installed in an image forming apparatus; and
changing the output voltage of the HVPS by correcting the high-voltage output control signal by using the information about the offset voltage, wherein the changing of the output voltage is performed by the image forming apparatus.

13. The method of claim 12, wherein the extracting of the information about the offset voltage comprises extracting the information about the offset voltage by reading the tag attached to the HVPS when the HVPS is installed in the image forming apparatus.

14. The method of claim 12, wherein the changing of the output voltage of the HVPS comprises:
acquiring a correction value by reading a look-up table pre-stored in a memory by using the information about the offset voltage, wherein the acquiring is performed by the image forming apparatus; and
changing the output voltage of the HVPS by correcting the high-voltage output control signal by using the correction value.

15. The method of claim 14, wherein the high-voltage output control signal is a PWM signal, and the correction value is duty information of the PWM signal.

16. A method of adjusting an output voltage of a power supply, the method comprising:
measuring an output voltage of the power supply;
recording information about an offset voltage in a tag attached to the power supply, wherein the offset voltage represents a difference between the measured output voltage of the power supply and a preset reference output voltage of the power supply;
extracting the information about the offset voltage by reading the tag attached to the power supply when the power supply is installed in an apparatus; and
changing the output voltage of the power supply by correcting an output control signal by using the information about the offset voltage, wherein the changing of the output voltage is performed by the apparatus.

17. A method of adjusting an output of a part installable in an apparatus, the method comprising:
measuring an output of the part;
recording information about an offset in a tag attached to the part, wherein the offset represents a difference between the measured output of the part and a reference output of the part;
extracting the recorded information when the part is installed in the apparatus; and
changing the output of the part by the apparatus by correcting a control signal based on the extracted information.
